(19) United States
(12) Patent Application Publication
(10) Pub. No.: US 2004/0019473 A1
(43) Pub. Date: Jan. 29, 2004

(54) System and method of processing a circuit design via critical design paths

(76) Inventors: David C. Burden, Fort Collins, CO (US); Tyson McGuffin, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/205,332

(22) Filed: Jul. 24, 2002

(51) Int. Cl. G06F 17/50

(52) U.S. Cl. 703/14

(57) ABSTRACT

A process for processing a circuit design. One or more critical design paths of the circuit design are determined. These paths may for example be determined relative to timing and/or current utilization. Design elements of the paths may be grouped by type (e.g., FETs, wires). The circuit design may be optimized by processing a reduced set of design elements as determined by the critical paths and grouping. Optimization may include modifying FET design element width, or a routing path of a wire design element, along a critical path of the design, and comparing the new optimization relative to preselected design goals such as timing and power consumption.

### BACKGROUND OF THE INVENTION

The prior art is familiar with computer aided design (CAD) software to create, verify and analyze electronic designs, including designs for microprocessor and digital signal processor (DSP) chips. Such software provides for system level design, verification, analysis and simulated testing of register-transfer logic (RTL), gates and physical layout structures. CAD software may further perform transistor-level timing analyses of electronic designs.

Advancements to prior art CAD software also attempts to detect problems in designs and to suggest optimizations. However, analyzing such designs is algorithmically complex; suggesting optimizations to such designs would make use of the CAD software unwieldy. In particular, algorithmic complexity may be estimated by a number of variables being processed; the number of variables may for example include the number of field effect transistors (FETs) in the design. In an analysis sorting algorithm, for example, the algorithmic complexity may increase in a relationship approximated by nlog(n), with n indicating the number of variables. In an analysis graph traversal algorithm, on the other hand, the algorithmic complexity may increase in a relationship approximated by n\hat{ }2. These algorithm complexities are further magnified when the CAD software attempts to suggest optimizations in the design.

With the increasing complexity of electronic designs—sometimes exceeding one billion components—the increase in algorithmic complexity requires an increase in computer processing power and/or speed. The increase in computer processing power and/or speed is not readily available due to hardware and software constraints. Prior art CAD software has attempted to analyze and optimize randomized segments of the circuit design, in order to decrease circuit complexity during optimization; however this is inefficient and may actually decrease circuit performance.

### SUMMARY OF THE INVENTION

Processing of a circuit design which includes targeting of one or more critical paths of an electronic design is disclosed. Each of the critical paths includes at least one design element, such as a FET or wire, of the design. Once identified, these paths are sorted according to the criticality of each path. This criticality may for example include (a) the speed of each path, as this speed may control the timing and/or frequency for all or part of the design, and/or (b) the current utilization of each path, as this current may define power consumption for all or part of the design. The design elements associated with each of the paths may be grouped by type (e.g., as a FET or wire) and then analyzed, or optimized, according to one or more design goals. By way of example, the design goals may include improving the speed and/or power consumption in the design.

In one aspect of the process, the grouping of the design elements may be limited to a user-defined number. That is, the number of design elements is predefined for subsequent processing. This provides flexibility in analyzing and/or optimizing the design with an available computing system.

In another aspect of the process, one or more characteristics of the grouped design elements may be modified in order to potentially optimize the path associated with those grouped design elements. By way of example, one of these characteristics may be the physical width of a FET. Another characteristic may be the oxide thickness of a FET. Another characteristic may be the layout of the source, gates and drains of the FET. Another characteristic may be the routing path of wires of the design; the routing path may for example include ninety-degree turns of wires within the design, which may create electro-migration.

Certain advantages may often be realized in accord with the process. By way of example, CAD software may more quickly analyze and/or optimize fewer FETs as compared to the complete set of FETs within a design. Moreover, in optimizing timing critical FETs as defined by the presorted critical timing paths, the greatest improvement to the overall design is typically determined without a breakdown in design functionality. Optimizing CAD software that operates on a subset of FETs within a design may further execute more quickly and efficiently, as compared to similar operations on all the FETs within the design, and without significant loss of accuracy. Targeted optimization based on timing critical paths and FETs may further improve the likelihood of successful optimization, as opposed to, for example, randomized optimizations attempted by certain prior art CAD software.

### BRIEF DESCRIPTION OF THE DRAWINGS

FIG. 1 shows one embodiment of a system for processing an electronic design;

FIG. 2 shows a flowchart illustrating one method for processing an electronic design; and

FIG. 3 schematically illustrates selection of one critical timing path in accord with the method of FIG. 2.

### DETAILED DESCRIPTION OF THE DRAWINGS

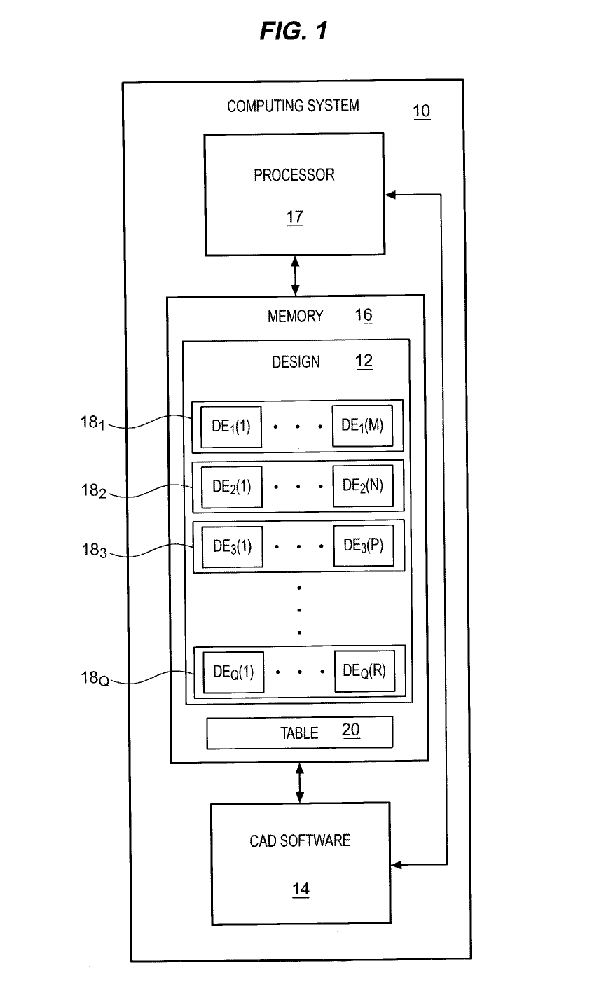

FIG. 1 shows computing system 10 for processing an electronic design 12 with CAD software 14. Design 12 and software 14 may be resident within and/or loaded to local computer memory 16. Processor 17 generally processes software 14 to analyze and/or optimize design 12 in accord with the teachings herein. Design 12 includes a plurality of design elements (DE). Design elements DE may include one or more FETs, wires, capacitors, diodes, operational amplifiers, resistors, logic gates and/or other design components.

Design elements DE generally connect together in one or more paths 18 through design 12. FIG. 1 illustratively shows paths 18₁, 18₂, 18₃ and 18_{Q}, where Q is an integer≧4: path 18₁ illustratively includes design elements DE₁(1) . . . DE₁(M); path 18₂ illustratively includes design elements DE₂(1) . . . DE₂(N); path 18₃ illustratively includes design elements DE₃(1) . . . DE₃(P); and path 18_{Q} illustratively includes design elements DE_{Q}(1) . . . DE_{Q}(R). Integers M, N, P, R may be the same or different, and may denote a small or large plurality of design elements DE within the associated path 18. Design 12 may include fewer or more paths 18 as a matter of design choice.

Processor 17 is configured to determine one or more critical paths of design 12, based on a criticality such as timing or current utilization. Processor 17 may utilize CAD software 14 that includes a program such as the commercially-available program PATHMILL, by Synopsys, Inc., located at 700 East Middlefield Road Mountain View, Calif., as known to those skilled in the art, to analyze timing paths of design 12. By way of example, processor 17 may determine that paths 18₁, 18₃ are much slower than paths 18₂, 18_{Q}, and therefore define paths 18₁, 18₃ as critical paths. In another example, processor 16 may determine that path 18₂ draws significantly more current than any other path 18, and therefore defines path 18₂ as a critical path. Processor 17 also preferably ranks these critical paths according to criticality. By way of example, processor 17 may rank a first critical path 18₁ ahead of a second critical path 18₃ because the first critical path is slower than the second critical path. Each critical path determined by processor 17 may be identified and stored in memory 16, such as within a table 20.

Processor 16 may be further configured to group design elements DE from each critical path according to type. In one example, grouped design elements DE are FETs; in another example, grouped design elements DE are wires. If for example path 18(1) is defined as a critical path because of timing, then design elements DE(1), DE(5) and DE(M) may illustratively represent FETs of path 18(1) while design elements DE(2), DE(3), DE(M−1) may illustratively represent wires of path 18(1). Each grouped design element DE determined by processor 17 may be identified and stored in memory 16 according to its associated path 18, such as within a table 20.

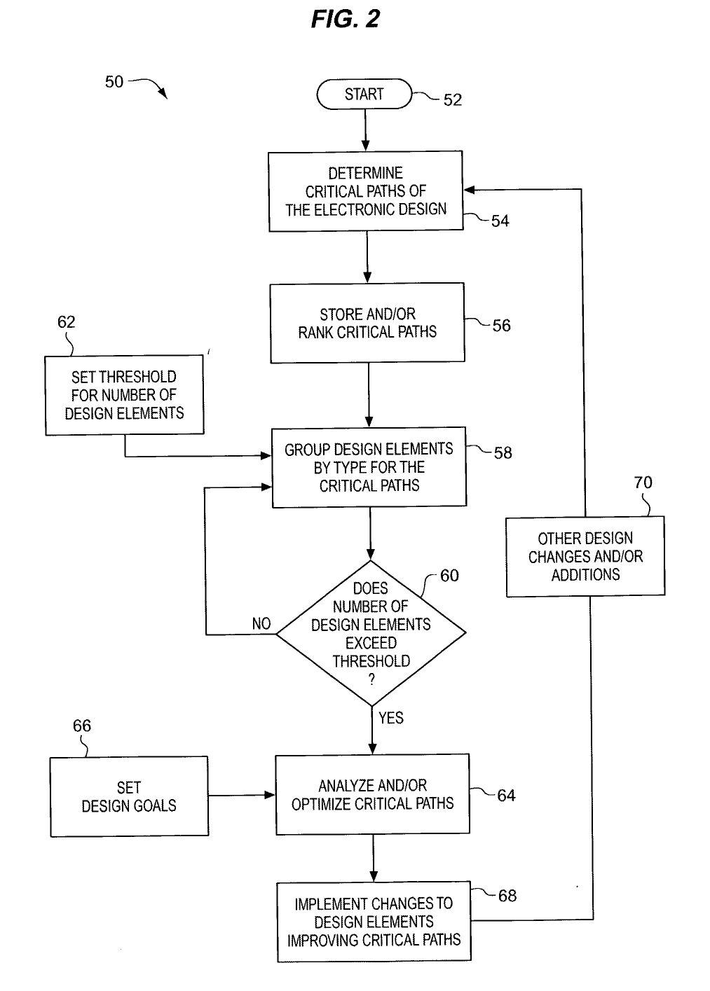

Once design elements of each critical path are grouped by type, processor 16 may process CAD software 14 to analyze and/or optimize design 12 according to design data stored in table 20, such as described in connection with FIG. 2.

FIG. 2 shows a flowchart 50 illustrating one method for processing an electronic design, such as design 12 of FIG. 1. The electronic design is identified at start 52. Critical paths of the design are determined in step 54. By way of example, step 54 may include determining critical timing paths of the design and/or step 54 may include determining critical current utilization paths of the design. The critical paths of the design may be sorted and ranked in memory (e.g., within table 20) in step 56. By way of example, step 56 may include ranking the critical paths in memory, with the slowest critical path ranked first, and the fastest critical path ranked last. Design elements for the critical paths are grouped according to type in step 58. By way of example, step 58 may include identifying FETs of each critical path and storing, in memory, an identifier for each FET and its association with its critical path. In another example, step 58 may include identifying each wire of a critical path and storing, in memory, an identifier for each wire and its association with the critical path. Steps 56 and 58 in one embodiment are reversed.

The process 54, 56, 58 of determining and storing critical paths, and grouping design elements by type may continue throughout the entire design. Optionally, this process terminates when the number of design elements grouped for subsequent processing reaches a user-defined limit, such as 500,000 FETs or one million wires, in order to reduce subsequent analysis and/or optimization complexity. Accordingly, step 58 may continue until the number of design elements identified and/or grouped reaches a user-defined threshold, as indicated by decision step 60. The user-defined threshold may be set as indicated by step 62.

Critical paths may be analyzed and/or optimized in step 64. The critical paths may be processed in step 64 according to path rank in step 56. In one example, step 64 may involve modifying one or more characteristics of the design elements grouped in connection with each critical path, and then analyzing the critical path relative to certain design goals. By way of example, the design goals may include a faster time and/or less current utilization for the critical path. Design goals may be set for use in processing 64 the critical paths as indicated by step 66.

The modified characteristics of the design elements generally depend upon design element type. In one example, the characteristic modified is the physical width and/or current capacity of a FET design element. Another example of a characteristic is the routing path of a wire design element.

If optimizations to certain design elements of one or more critical paths are shown to improve the design—such as if a critical path is faster and/or draws less current—then the design elements associated with the critical paths are modified in accordance with the optimization in step 68. The process of steps 54-66 may then repeat, as desired, particularly when other design changes and/or segments are added 70 to the overall electronic design.

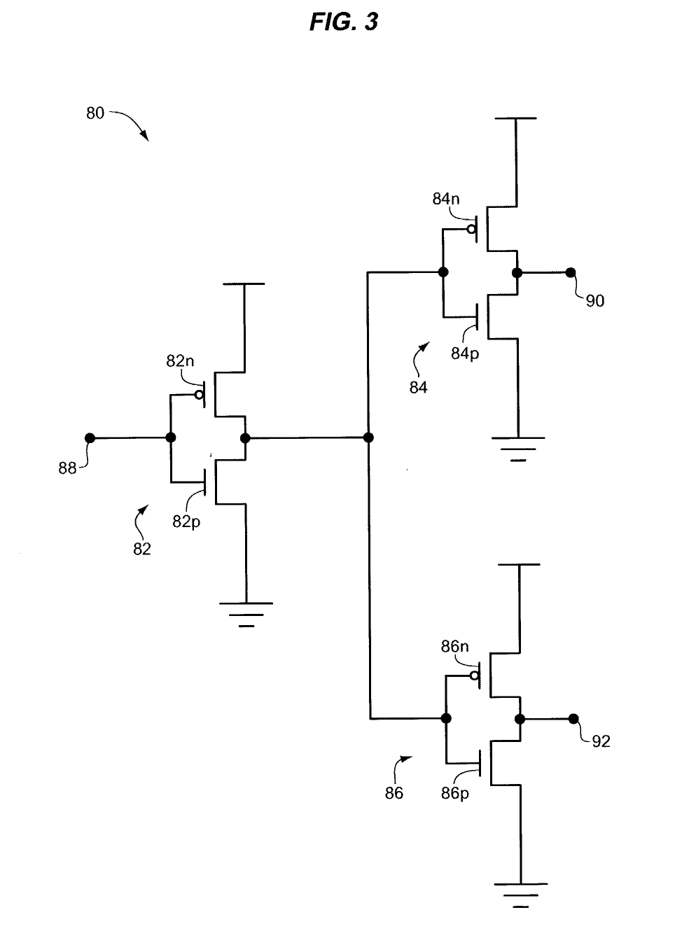

FIG. 3 shows a circuit 80 with three inverters 82, 84 and 86. Inverter 82 has two FETs 82n, 82p; inverter 84 has two FETs 84n, 84p; and inverter 86 has two FETs 86n, 86p. Circuit 80 has an input node 88 and two output nodes 90, 92: node 90 is also an output node for inverter 84; node 92 is also an output node for inverter 86. Circuit 80 thus has two paths, one from input node 88 (“path one”) to output node 90 and one from input node 88 to output node 92 (“path two”). In this example, inverter 86 is larger than inverter 84. Accordingly, path one is slower than path two and path one may be identified as a critical timing path in accord with the teachings herein. Moreover, FETs 82n, 82p, 84n and 84p may thus be grouped for subsequent optimization, as in step 58, FIG. 2.

Steps of flowchart 50, FIG. 2 may be embodied within a machine readable storage medium such as a computer disk. The storage medium may contain a series of program instructions for a computer that processes the circuit design. By way of example, these instructions may direct the computer to determine one or more critical design paths of the circuit design, group design elements by type for each of the critical design paths, and process the circuit design in comparison to one or more design goals. The instructions may further direct the computer to determine critical timing paths of the circuit design and/or to group FET design elements of the circuit design, for example. A user may interact with the computer such that the instructions set design goals, e.g., speed and/or current consumption of the circuit design. In another example, the instructions may direct the computer to modify one or more of a source, drain and gate characteristic of FET design elements to achieve the design goals.

What is claimed is:

1. A process for processing a circuit design, comprising the steps of:
determining one or more critical design paths of the circuit design;
grouping design elements by type for each of the critical design paths; and
processing the circuit design in comparison to one or more design goals.

2. A process of claim 1, further comprising the step of setting the design goals.

3. A process of claim 2, the step of setting the design goals further comprising selecting one of speed and current consumption of the circuit design.

4. A process of claim 1, the step of determining one or more critical design paths further comprising determining critical timing paths of the circuit design.

5. A process of claim 1, the step of determining one or more critical design paths further comprising determining current utilizations of the paths of the circuit design.

6. A process of claim 1, the step of grouping further comprising identifying and grouping FET design elements of the circuit design.

7. A process of claim 1, the step of grouping further comprising identifying and grouping wire design elements of the circuit design.

8. A process of claim 1, the step of grouping further comprising grouping design elements until a user-selected threshold is reached.

9. A process of claim 1, the step of processing further comprising modifying one or more characteristics of the design elements.

10. A process of claim 9, the step of processing further comprising modifying at least one of a physical width of a FET design element, a current capacity of a FET design element, and a layout of a FET design element.

11. A process of claim 10, the step of modifying the layout of the FET design element comprising modifying at least one of a source, drain and gate configuration of the FET design element.

12. A process of claim 9, the step of processing further comprising modifying a routing path of a wire design element.

13. A system for processing a circuit design, comprising:
means for determining one or more critical design paths of the circuit design;
means for identifying design elements by type for each of the critical design paths; and
means for optimizing the circuit design relative to one or more design goals.

14. A system of claim 13, the means for determining comprising means for identifying and ranking critical timing paths.

15. A system of claim 13, the means for determining comprising means for identifying and ranking critical current utilization paths.

16. A system of claim 13, the means for identifying comprising means for grouping at least one of FET design elements and wire design elements.

17. A system of claim 13, the means for optimizing comprising means for modifying FET design element characteristics relative to a design goal of increasing speed for FET design elements of the critical design paths.

18. A system of claim 17, the design element characteristics comprising one or both of physical FET width and FET current capacity.

19. A system of claim 13, the means for optimizing comprising means for modifying wire characteristics relative to a design goal of decreasing current consumption of the critical design paths.

20. A system of claim 19, the characteristics comprising one or more wire routing paths associated with the critical paths.

21. A computer readable storage medium tangibly embodying program instruction for processing a circuit design, the processing comprising the steps of: determining one or more critical design paths of the circuit design; grouping design elements by type for each of the critical design paths; and processing the circuit design in comparison to one or more design goals.

22. A computer readable storage medium of claim 21, the step of determining comprising determining critical timing paths of the circuit design, the step of grouping comprising grouping FET design elements of the circuit design, and further comprising the step of setting the design goals as one or both of speed and current consumption of the circuit design.

23. A computer readable storage medium of claim 22, the processing further comprising the step of modifying at least one of source, drain and gate characteristic of the FET design elements relative to achieving the design goals.
